(19) United States
(12) Patent Application Publication
(10) Pub. No.: US 2006/0087183 A1
(43) Pub. Date: Apr. 27, 2006

(54) Rotary electric machine

(75) Inventors: Toshinori Tanaka, Tokyo (JP); Keiichi Fukazawa, Tokyo (JP); Kyouhei Yamamoto, Tokyo (JP); Yoshitaka Masuda, Tokyo (JP); Kengo Fujimoto, Tokyo (JP); Hirokazu Sakuda, Hyogo (JP); Masayasu Miyajima, Tokyo (JP); Yuusuke Matsui, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/097,248

(22) Filed: Apr. 4, 2005

(30) Foreign Application Priority Data
Oct. 26, 2004 (JP) P2004-311228

(51) Int. Cl. H02K 5/00; H02K 23/04; H02K 1/28

(52) U.S. Cl. 310/89; 310/218; 310/154.13

(57) ABSTRACT

A rotary electric machine is provided in which the press-fit load of a stator magnetic pole to a frame is stabilized, thus stabilizing the performance of the rotary electric machine, and that has high anti-corrosiveness and anti-rusty sealing property and is inexpensive. Particularly a rotary electric machine suitable for a motor for motor power steering apparatus is provided. In a rotary electric machine having a stator magnetic pole press-fitted and fixed on an inner circumferential surface of a cylindrical frame made of a steel plate and having a rotor arranged via a gap to an inner circumferential side of the stator magnetic pole, the frame is formed by pressing a surface-treated steel plate having a plating layer of aluminum, magnesium, silicon, and zinc for the remaining part formed on a surface of the steel plate, into a cylindrical shape.

### BACKGROUND OF THE INVENTION

1. Field of the Invention

This invention relates to a rotary electric machine to which a stator magnetic pole is press-fitted and fixed on the inner circumferential surface of its cylindrical frame.

2. Description of the Related Art

A rotary electric machine of this type has a frame that is cast by using a casting aluminum material, and a stator core is press-fitted and fixed on the inner side of a steel pipe cast in this frame, for example, as disclosed in Patent Reference 1. With this structure, since the steel pipe has a coefficient of linear expansion approximate to the coefficient of linear expansion of the stator core, fixation and holding of the stator core by the steel pipe up to a high-temperature range is realized.

A rotary electric machine disclosed in Patent Reference 2 has a stator core press-fitted into a cylindrical part of a supporting bracket, and a ring member is engaged with an outer circumferential part of the cylindrical part facing the part where the stator core is press-fitted. Therefore, the rigidity of the supporting bracket is increased and vibration and noise of the electric motor can be prevented.

Patent Reference 1: JP-A-2001-169500

Patent Reference 2: JP-A-2002-34202

In the rotary electric machine thus formed by press-fitting and fixing the outer circumferential surface of the stator core on the inner circumferential surface of the cylindrical frame made of an iron material such as steel pipe, it is important to manage the dimensions of the inner circumferential surface and the outer circumferential surface. Variance in the dimensions of these two surfaces causes variance in the press-fit margin and it also causes variance in the press-fit load. If the press-fit margin is further increased in order to securely fix the stator core, the press-fit load may become excessively large and its stress deteriorates the roundness of the inner circumferential surface of the stator core. This may cause problems such as variance in the performance of the rotary electric machine and increase of cogging torque.

In the rotary electric machine having a frame made of an iron material, which becomes an outer shell of the rotary electric machine, for example, galvanization of approximately 5 μm is generally performed in order to improve anti-corrosiveness. To improve anti-corrosiveness further, cationic coating or the like may be performed. The above-described Patent References 1 and 2 include no description of galvanization, cationic coating or the like. However, in the case where galvanization or the like is performed, there is a problem of further variance in the press-fit load. In the case where cationic coating or the like is performed, there is a problem that masking must be carried out in order to prevent the coating from adhering to the inner circumferential surface where the stator core is to be press-fitted.

The above-described Patent References 1 and 2 include no description of a waterproof seal or the like. However, there is a problem that the adhesive strength between the sealant and the frame at a junction part between the frame of the rotary electric machine and the housing (bracket) tends to vary. Therefore, a problem arises that the adhesive strength between the surface-treated surface of the frame and the sealant must be secured.

### SUMMARY OF THE INVENTION

It is an object of this invention to provide a rotary electric machine that realizes stable press-fit load of a stator magnetic pole into its frame, achieves stable performance, good anti-corrosiveness and anti-rust seal performance, and is inexpensive, and particularly a rotary electric machine suitable for a motor for motor power steering apparatus.

According to this invention, in a rotary electric machine having a stator magnetic pole press-fitted and fixed on an inner circumferential surface of a cylindrical frame made of a steel plate and having a rotor arranged via a gap to an inner circumferential side of the stator magnetic pole, the frame is formed by pressing a surface-treated steel plate having a plating layer of aluminum, magnesium, silicon, and zinc for the remaining part formed on a surface of the steel plate, into a cylindrical shape.

According to this invention, since the plating layer of the surface-treated steel plate used as the frame has high anti-corrosiveness and sufficient hardness, the plating layer can be formed as a thin film, a stable coefficient of friction can be acquired, and the press-fit load of the stator magnetic pole is stabilized. Also, as deformation of the frame and stress on the stator magnetic pole can be reduced, it is possible to provide a rotary electric machine that has less variance in performance, restrained increase of cogging torque and good anti-corrosiveness and that is inexpensive.

Particularly when the rotary electric machine according to this invention is applied to a motor for motor power steering apparatus, increase of cogging torque and torque ripple is restrained and good steerage is achieved, which is preferred.

### BRIEF DESCRIPTION OF THE DRAWINGS

FIG. 1 is a sectional view of a brushless motor, showing the structure of Embodiment 1 of this invention.

FIGS. 2A and 2B are side and sectional views of a frame in Embodiment 1.

FIGS. 3A and 3B are side and sectional views of a stator magnetic pole in Embodiment 1.

FIG. 4 is a front view of another example of stator magnetic pole in Embodiment 1 after winding (before rounding).

FIGS. 5A and 5B are side and sectional views of complete state (after rounding) of the stator magnetic pole of FIG. 4.

FIG. 6 is a sectional view of a brushless motor, showing the structure of Embodiment 2 of this invention.

FIGS. 7A and 7B are side and sectional views of a stator magnetic pole in Embodiment 2.

FIGS. 8A and 8B are side and sectional views showing the state where the stator magnetic pole is press-fitted into a frame in Embodiment 2.

FIGS. 9A to 9C are views showing comparative data of various surface-treated steel plates used for the frame.

### DETAILED DESCRIPTION OF THE PREFERRED EMBODIMENTS

### Embodiment 1

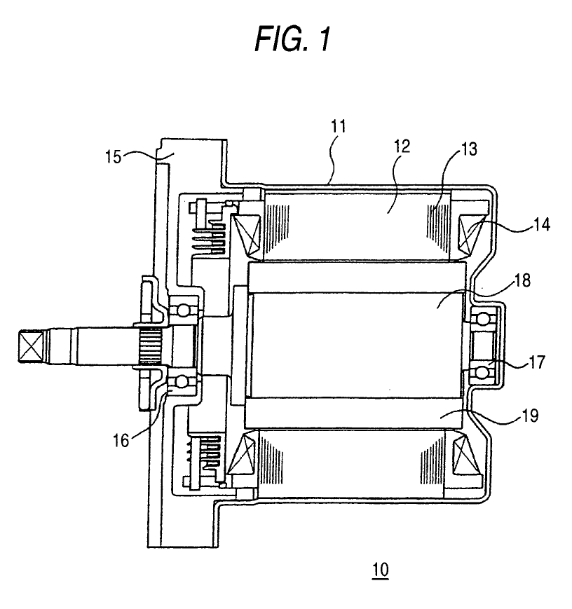

FIG. 1 is a sectional view showing the structure of a brushless motor in Embodiment 1 of this invention. In a brushless motor 10, a stator magnetic pole 12 formed by winding a stator coil 14 on a stator core 13 is inserted by press-fitting to the inner circumference of a frame 11 made of a steel plate and formed in a bottomed cylindrical shape, and a housing 15 made of an aluminum material is attached to an opening end side of the frame 11. A front bearing 16 is provided at a central part of the housing 15, and a rear bearing 17 is held on the bottomed side of the frame 11. A rotor 18 is integrally constructed with a permanent magnet 19 fixed by an adhesive to a shaft made of a steel material, and the rotor 18 rotates as it is supported by the front bearing 16 having its outer ring fixed to the housing 15 and by the rear bearing 17 having its outer ring supported by the frame 11.

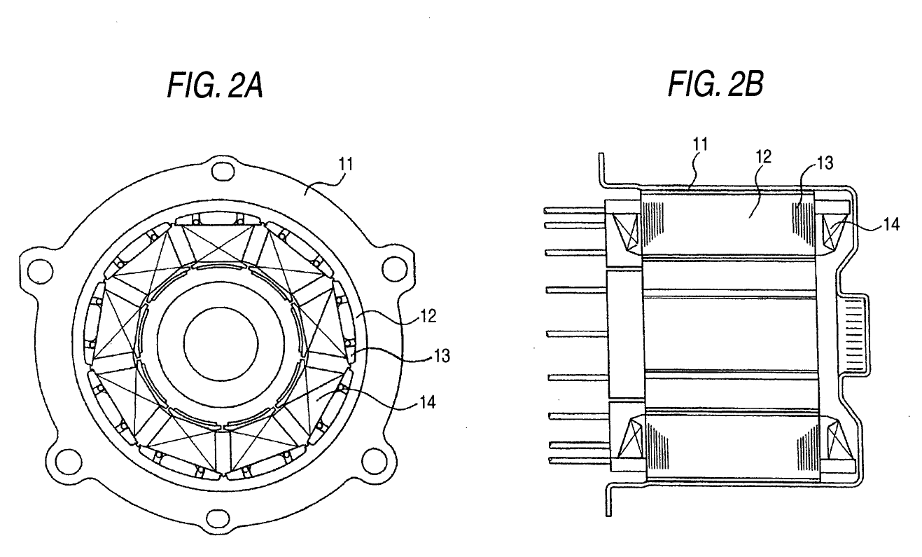

FIGS. 2A and 2B are side (as viewed from the housing side) and sectional views of the frame 11 in which the stator magnetic pole 12 having the stator coil 14 wound on the stator core 13 has been press-fitted. The frame 11 is formed by press-molding a surface-treated steel plate having a plating layer of aluminum, magnesium, silicon, and zinc for the remaining part formed on its surface, into a bottomed cylindrical shape. The bottom part has a shape to house the outer ring of the rear bearing 17.

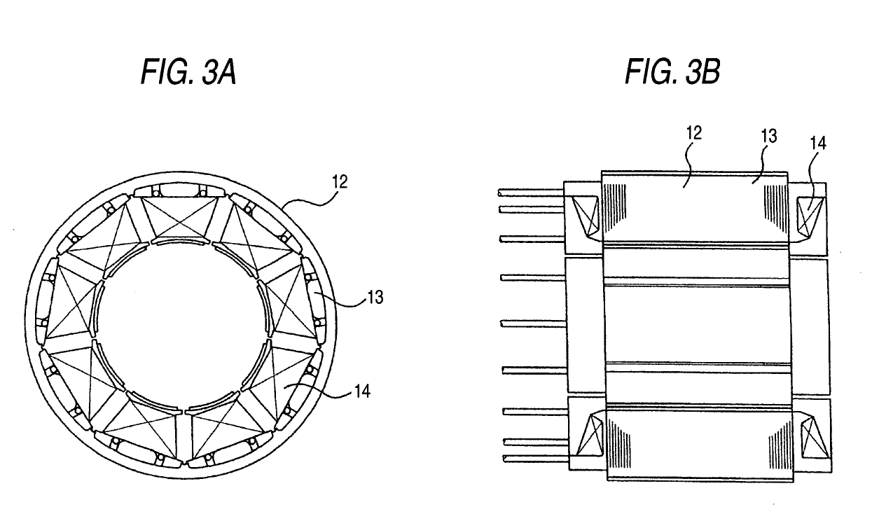

FIGS. 3A and 3B are side and sectional views of the stator magnetic pole 12. The stator magnetic pole 12 is formed by winding the stator coil 14 on the stator core 13 formed in a circular shape by stacking iron core segments. The outer circumferential surface of the stator core 13 is press-fitted and fixed to the inner circumferential surface of the frame 11.

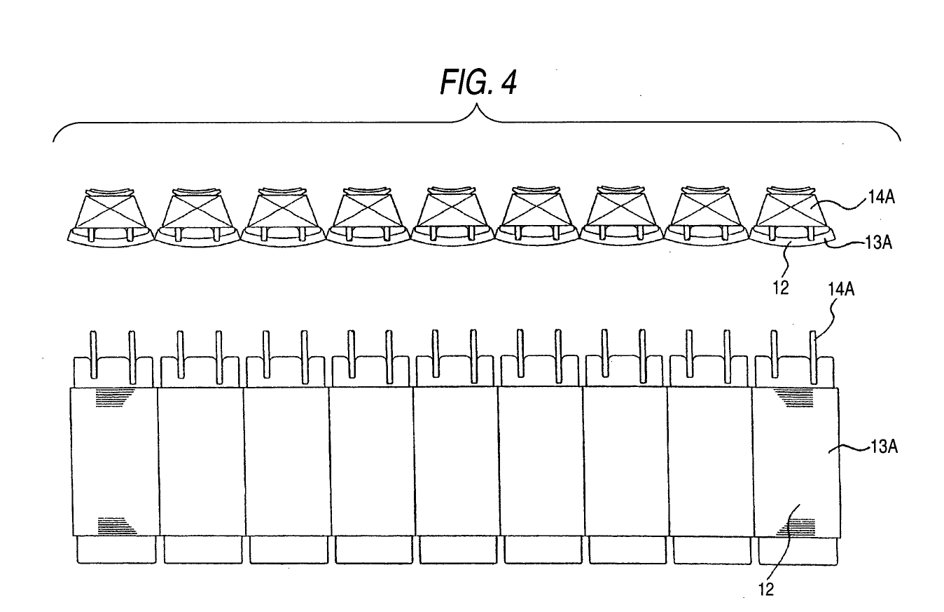

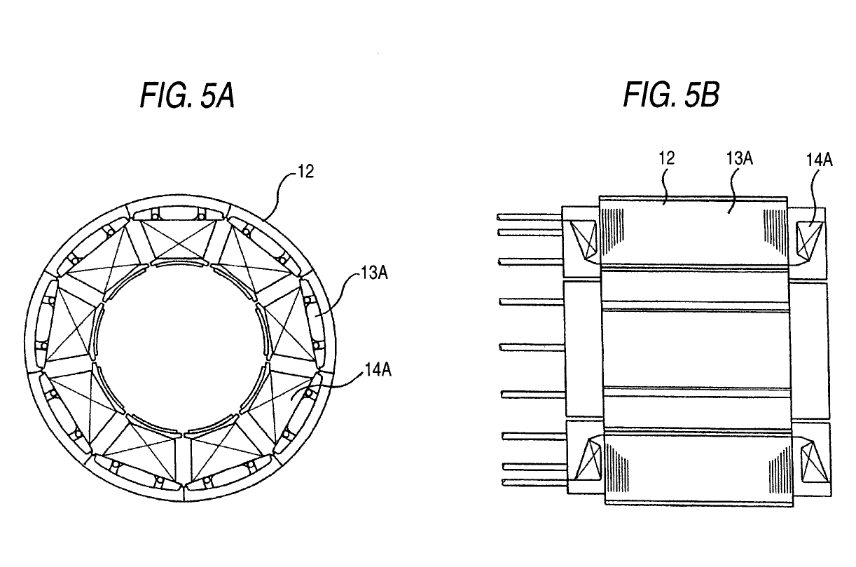

This stator magnetic pole 12 can also be formed by winding a stator coil 14A on a stator core 13A formed in a plate shape by stacking multiple iron core segments made of electromagnetic steel plates as shown in FIG. 4, and then bending this into a circular shape as shown in FIG. 5. In this case, the stator core 13A can be easily rounded and the stator core 13A can be press-fitted and fixed to the frame 11 as in the case of FIG. 3. Thus, the manufacturing cost can be lowered.

In the brushless motor 10 constructed as described above, the frame 11 has an anti-rusty performance of the surface-treated steel plate, and the fixation of the stator magnetic pole 12 to the frame 11 is carried out by press-fitting and engaging the outer circumferential part of the stator core of the stator magnetic pole 12 to the inner circumferential part of the frame 11. Therefore, no adhesive, fixture or the like is necessary and the manufacturing cost can be lowered.

Hot-dip galvanization is generally performed for anticorrosion of steel materials. In this Embodiment 1, a steel plate made by Nippon Steel Corporation, trade name “Super Dyma” (hereinafter referred to as SD), is used for the frame 11. This SD contains zinc as a principal component of plating layer, with 2 to 19% by mass of aluminum, 1 to 10% by mass of magnesium and 0.01 to 2% by mass of silicon added thereto. It is a highly anticorrosive plated steel plate with its anti-corrosiveness improved by composite effects of these added elements. Particularly silicon improves the processability of the plating layer containing aluminum and also enhances the corrosion restraining effect by its combined action with magnesium. Because of its high anti-corrosiveness, SD has been used mainly for construction materials. Typical SD contains zinc as a principal component, with 11% by mass of aluminum, 3% by mass of magnesium and 0.2% by mass of silicon added thereto.

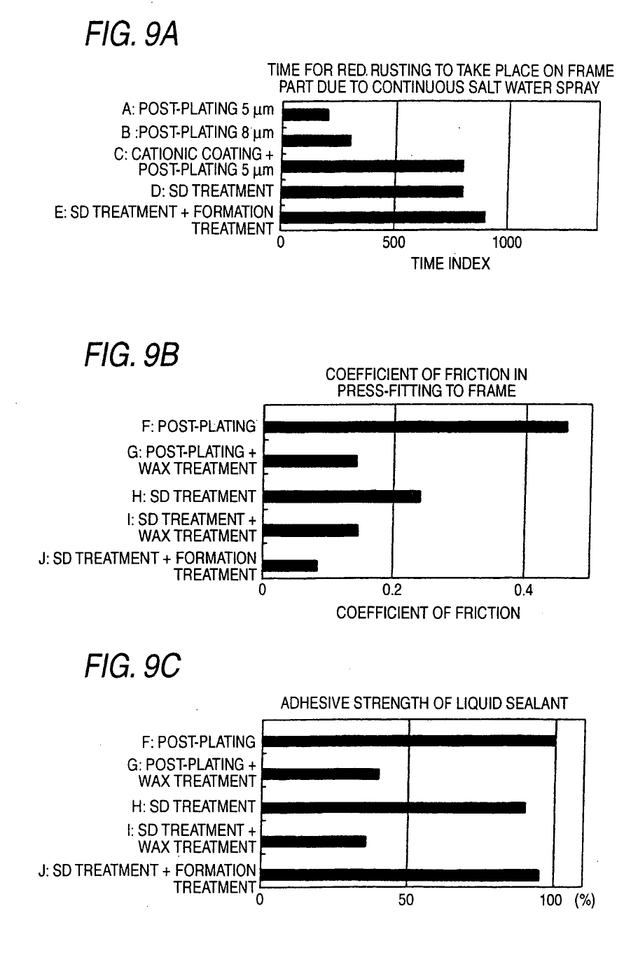

FIG. 9A shows data acquired by comparing the time for red rusting to take place due to continuous salt water spray in the case of using the surface-treated steel plate on which various kinds of surface treatment have been performed, for the frame 11. A shows the result of performing ordinary galvanization of 5 μm. B shows the result of performing ordinary galvanization of 8 μm. C shows the result of performing ordinary galvanization of 5 μm on a cationic-coated product. D shows the result of performing treatment to form a plating layer containing 11% by mass of aluminum, 3% by mass of magnesium, 0.2% by mass of silicon, and zinc for the remaining part (hereinafter referred to as SD treatment). E shows the result of further performing formation treatment after SD treatment. As the formation treatment, for example, a technique of applying a mixture containing urethane resin, wax and additives on an SD-treated surface at approximately 1 μm can be used.

From these comparative data, it is obvious that the case D and case E of performing SD treatment exhibit excellent anti-rust. As a reason for this, it is considered that since the quantity of elution of zinc existing in the aluminum contained in the SD-treated product can be restrained to a small quantity, the anti-rusty effect lasts for a long period. It is also considered that performing formation treatment in addition to SD treatment slight improves the anti-rusty effect but the primary effect is of SD treatment.

Next, FIG. 9B shows data acquired by comparing the coefficient of friction between the frame 11 and the stator magnetic pole 12 that is related to the magnitude of the frictional force at the time of press-fitting the stator magnetic pole 12 to the frame 11 in the case of using the surface-treated steel plate on which various kinds of surface treatments have been performed, for the frame 11. F shows the result of only performing ordinary post-plating (galvanization). G shows the result of further performing wax treatment after ordinary post-plating (galvanization). H shows the result of performing SD treatment. I shows the result of further performing wax treatment after SD treatment. J shows the result of further performing formation treatment after SD treatment.

That is, in the case where only post-plating is performed on the surface of the frame 11 as in case F, since large friction occurs, a very large press-fitting force is necessary and this may cause deformation and damage to the frame 11 and the stator magnetic pole 12. G shows the case where wax is applied on a post-plated surface for the purpose of reducing the press-fitting force and thus prevent such deformation and the like. In SD treatment of H, since the plating layer has higher hardness than post-plating, the coefficient of friction can be reduced to a certain extent without applying wax. The coefficient of friction can be further reduced by performing wax treatment in addition to SD treatment as in case I. Moreover, if formation treatment is performed in addition to SD treatment as in case J, a coefficient of friction better than the coefficient of friction in the case of wax treatment can be acquired. Since the formation treatment in this case forms a lubricant coating that is strongly bonded to the SD surface, more stable friction than in the case of the wax treatment coating can be acquired.

FIG. 9C shows data acquired by comparing the adhesive strength between a liquid sealant and the frame 11 in the case where a liquid sealant for the purpose of waterproofing is applied between the frame 11 and the housing 15 and where the same surface-treated steel plates F to J as in FIG. 9B are used for the frame 11. In this case, it is necessary to secure an adhesive strength between the liquid sealant and the frame 11, particularly the frame 11 on which coating has been performed as surface treatment, in order to secure the sealing effect of the liquid sealant. As the liquid sealant in this case, a liquid sealant containing silicone as a principal component (manufactured by Three Bond Co., Ltd.) can be effectively used.

As can be seen from these comparative data, with respect to post-plating of F, SD treatment of H, and SD treatment plus formation treatment of J, substantially the same adhesive strength can be expected and the sealant effect is high. However, with respect to post-plating plus wax treatment of G and SD treatment plus wax treatment of I, the adhesiveness is hindered by the influence of the wax. The sealant effect is low and waterproof performance cannot be expected.

Particularly, in the case of SD treatment plus formation treatment of J, the above-described coefficient of friction can be stabilized while the adhesiveness can be secured. Therefore, by performing coating treatment on the surface of the frame 11, the stator magnetic pole 12 can be stably press-fitted without causing deformation or damage, and stable waterproof performance can be expected. Thus, reduction in the manufacturing cost and high anti-rust can be realized.

As described above, according to this Embodiment 1, the frame is formed by pressing a surface-treated steel plate having a plating layer of aluminum, magnesium, silicon, and zinc for the remaining part, formed on its surface, into a cylindrical shape. Therefore, the plating layer has high anti-corrosiveness and sufficient hardness, the plating layer can be formed as a thin film and has a stable coefficient of friction. Thus, the press-fit load of the stator magnetic pole is stabilized. Moreover, since deformation of the frame and stress on the stator core can be reduced, a rotary electric machine can be provided that has less variance in performance, restrained increase of cogging torque and high anti-corrosiveness and that is inexpensive. Particularly in the case where this rotary electric machine is applied to a motor for motor power steering apparatus, increase of cogging torque and torque ripple can be restrained and good steerage can be achieved, which is preferred.

Particularly, in the case where a plating layer containing 11% by mass of aluminum, 3% by mass of magnesium, 0.2% by mass of silicon, and zinc for the remaining part (SD treatment), is employed, the press-fit load of the stator magnetic pole can be effectively stabilized. As the availability of the steel plate is high, an inexpensive rotary electric machine can be provided.

In the case where a surface-treated steel having a lubricant coating provided by formation treatment on an SD-treated layer is used, the coefficient of friction is reduced and the press-fit load of the stator magnetic pole can be further stabilized. Since it is the surface-treated steel plate having the lubricant coating provided thereon in advance, its productivity is high. The hot-dip galvanized steel plate containing aluminum, magnesium and silicon can be easily applied as a frame of a rotary electric machine to which the stator magnetic pole is to be press-fit and fixed.

Moreover, in the case where a liquid sealant is applied to the abutment surface between the frame and the housing made of an aluminum material and abutted against the frame, airtightness improves and high waterproof property is achieved. Thus, electrolytic corrosion between the frame and the housing is prevented and durability improved.

### Embodiment 2

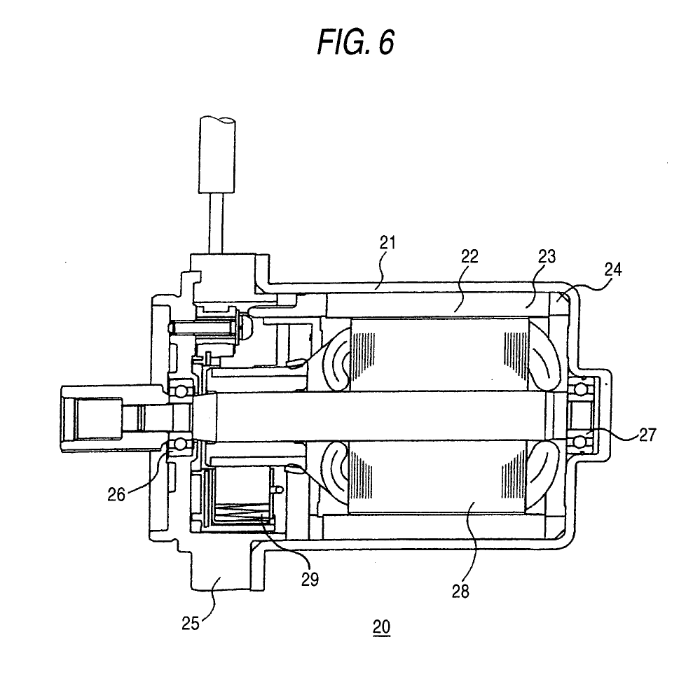

FIG. 6 is a sectional view showing the structure of a rotary electric machine (brush motor) according to an embodiment of this invention. 20 represents a brush motor, which is a rotary electric machine. 21 represents a frame that forms a yoke. 22 represents a stator magnetic pole, which is constituted by a permanent magnet 23 and a magnet holder 24 holding this permanent magnet. 25 represents a housing. 26 represents a front bearing. 27 represents a rear bearing. 28 represents an armature. 29 represents a brush holder. The armature 28 has a core that is formed by stacking electromagnetic steel plates and fixed to a shaft, and it has a coil wound thereon. The armature 28 is rotatably supported by the front bearing 26 and the rear bearing 27.

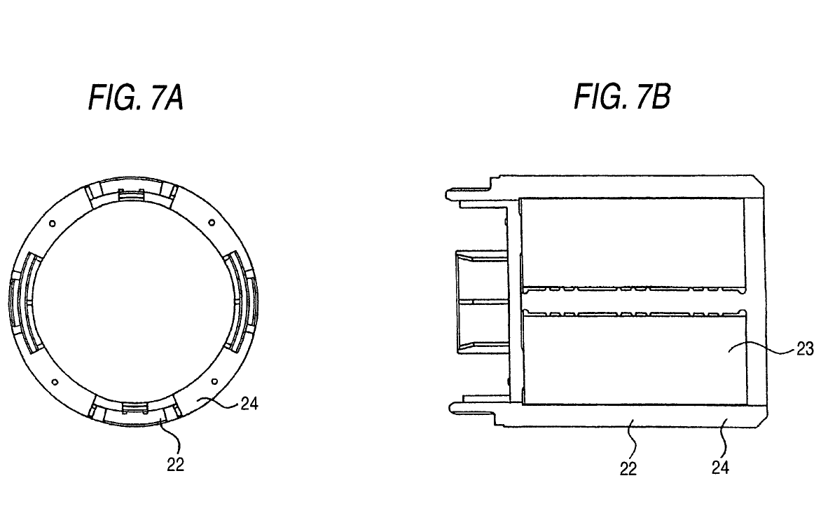

FIGS. 7A and 7B are side and sectional views of the stator magnetic pole 22. The permanent magnet 23 is supported as it is engaged with a supporting frame of the magnet holder 24.

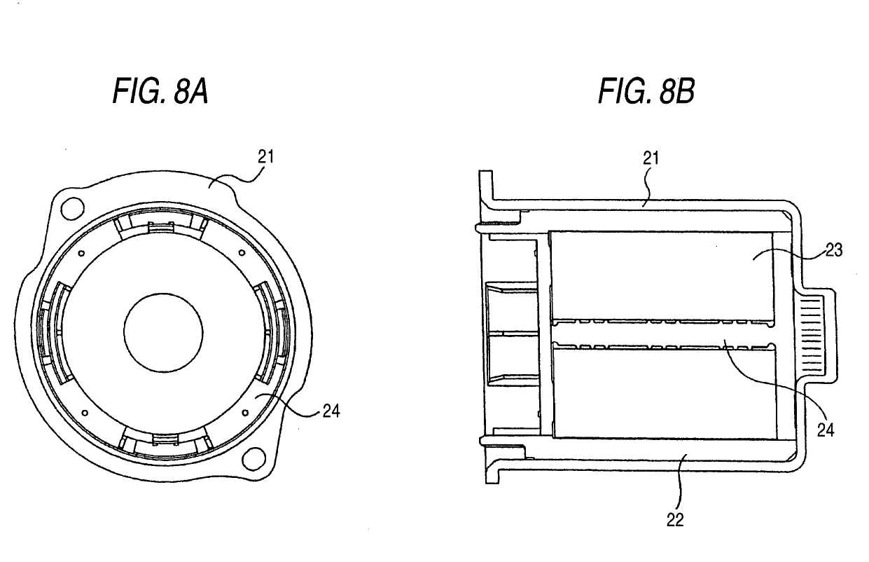

FIGS. 8A and 8B are side and sectional views showing the structure of mounting the stator magnetic pole 22, which is formed by the permanent magnet 23 and the magnet holder 24, to the frame 21.

Also in this Embodiment 2, the frame 21 is formed by press-molding a surface-treated steel plate similar to that of Embodiment 1. On its inner circumferential part, the stator magnetic pole 22, which is formed by the permanent magnet 23 and the magnet holder 24, is press-fitted, engaged, fixed and supported. The frame 21 also has a shape to house the rear bearing 27.

Since the rotary electric machine of Embodiment 2 is constituted as described above, it has high anti-rusty performance as in Embodiment 1. As the stator magnetic pole 22, which is formed by the permanent magnet 23 and the magnet holder 24, can be fixed without requiring adhesive or fixture, the manufacturing cost can be reduced.

Moreover, since the stator magnetic pole 22 is press-fitted and fixed to the inner circumferential surface of the frame 21 made of the surface-treated steel plate, the press-fit load of the stator magnetic pole 22 can be stabilized as in Embodiment 1, and a rotary electric machine having stable performance and restrained increase of cogging torque can be provided.

1. A rotary electric machine comprising a cylindrical frame, a stator magnetic pole press-fitted and fixed on an inner circumferential surface of the cylindrical frame, and a rotor arranged via a gap to an inner circumferential side of the stator magnetic pole, wherein the frame comprises a surface-treated steel plate including a plating layer of aluminum, magnesium, silicon, and zinc formed on a surface of the steel plate, and being press-formed into a cylindrical shape.

2. The rotary electric machine according to claim 1, wherein the plating layer of the surface-treated steel plate contains 11% by mass of aluminum, 3% by mass of magnesium, 0.2% by mass of silicon, and zinc for the remaining part.

3. The rotary electric machine according to claim 1, wherein the surface-treated steel plate further includes a lubricant coating provided on the plating layer.

4. The rotary electric machine according to claim 1, further comprising a housing made of an aluminum material and abutted against the frame, and a liquid sealant applied to an abutment surface between the frame and the housing.

5. The rotary electric machine according to claim 1, wherein the stator magnetic pole comprises a stator core formed by stacking iron core segments, and a stator coil wound on the stator core, and an outer circumferential surface of the stator core is press-fitted and fixed to an inner circumferential surface of the frame.

6. The rotary electric machine according to claim 5, wherein the stator magnetic pole is formed by first winding the stator coil on the stator core formed into a plate shape by stacking iron core segments, and then bending the stator core into a circular shape.

7. The rotary electric machine according to claim 1, wherein the stator magnetic pole is formed by a permanent magnet and a magnet holder that holds the permanent magnet.

8. The rotary electric machine according to claim 1, wherein the rotary electric machine is a motor for a motor power steering apparatus.
